(19) United States
(12) Patent Application Publication
(10) Pub. No.: US 2010/0201006 A1
(43) Pub. Date: Aug. 12, 2010

(54) METHOD AND APPARATUS FOR STABLE AND ADJUSTABLE GAS HUMIDIFICATION

(76) Inventors: Ron C. Lee, Bloomsbury, NJ (US); Naresh Suchak, Glen Rock, NJ (US); Nils Lindman, Stockholm (SE)

Correspondence Address: The BOC Group, Inc., 575 MOUNTAIN AVENUE, MURRAY HILL, NJ, 07974-2082, US

(21) Appl. No.: 12/696,103

(22) Filed: Jan. 29, 2010

Related U.S. Application Data
(60) Provisional application No. 61/152,023, filed on Feb. 12, 2009.

(51) Int. Cl. B01F 3/04

(52) U.S. Cl. 261/16

(57) ABSTRACT

Stable and adjustable humidification of a gas are achieved by separating a gas stream into two streams and humidifying one of the gas streams. The desired level of humidification of the final product gas stream can be achieved by adjusting the relative flow rates of the two gas streams so that when they are combined to form a final product gas stream that has the appropriate level of humidity.

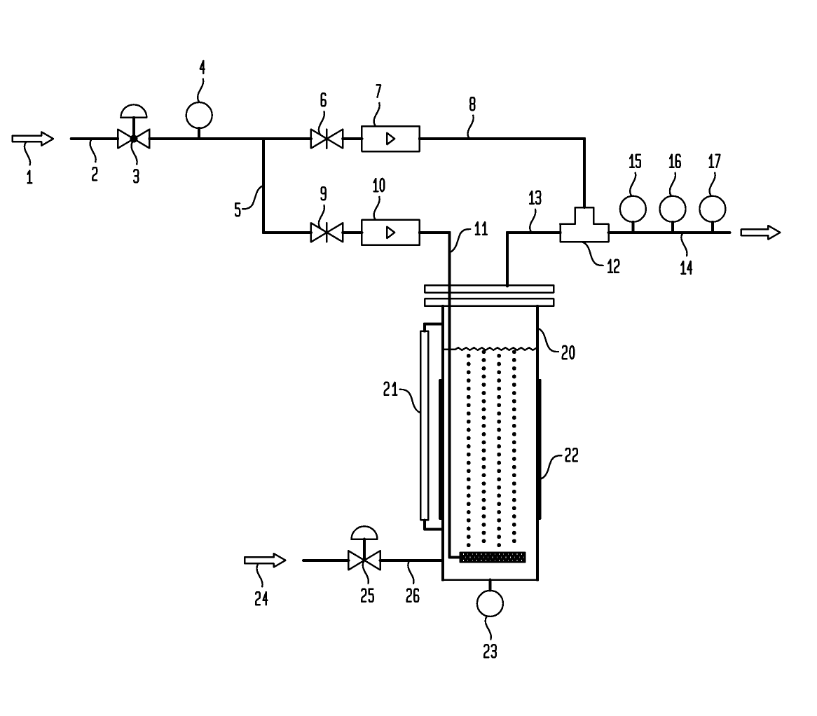

### CROSS REFERENCE TO RELATED APPLICATIONS

The present application claims priority from U.S. patent application Ser. No. 61/152,023 filed Feb. 12, 2009.

### BACKGROUND OF THE INVENTION

The invention relates to a method and apparatus for producing a continuously adjustable relative humidification of a gas stream. The method uses a mixing technique which is stable and reliable under varying operating conditions.

It is known that the maximum amount of equilibrium water vapor that can be contained in a nitrogen gas stream is a unique function of the temperature and pressure of the mixed stream. The maximum amount corresponds to a condition of 100% relative humidity. For any less amount of water vapor, the relative humidity is simply the ratio of the actual amount of water vapor contained in the nitrogen to the maximum amount of water vapor at saturation.

Various humidification devices that use bubble columns to produce generally saturated gas streams are known. These devices in some instances provide for heat input and/or temperature control of the liquid in the bubble column to provide a degree of control over the amount of humidification. U.S. Pat. No. 6,299,147 teaches the use a two stage humidification device that provides precise humidification through pressure control of a saturated gas stream. Steam is also employed for producing a saturated gas stream. While U.S. Pat. No. 6,299,147 does teach the production of a variable relative humidity, it is primarily for calibration purposes and relies on complex mechanical and control arrangements. Most of these earlier devices are directed towards methods of producing a 100% saturated gas stream.

As such there is a recognized need to produce a gas stream with a continuously variable degree of relative humidity that is both relatively simple in its production but also can be produced over a broad range of flow and pressure conditions.

### SUMMARY OF INVENTION

The invention addresses these needs as it provides a method and apparatus for producing a continuously adjustable relative humidification of a gas stream.

The invention provides for a method of humidifying a gas stream comprising the steps of:

splitting a dry gas stream into a first gas stream and a second gas stream;

feeding said second gas stream to a humidification unit, thereby forming a nearly saturated humidified gas stream; and

combining said first gas stream and said humidified gas stream.

Alternatively, the invention provides for a method of humidifying a gas stream to a desired amount of humidification comprising the steps:

measuring the flow rate and humidity of a first gas stream;

directing a second gas stream to a humidification unit thereby producing a nearly saturated humidified second gas stream;

measuring the flow rate and humidity of said humidified second gas stream; combining said first gas stream and said humidified second gas stream to produce a gas stream having the desired level of humidification.

The invention further provides for an apparatus for providing humidification to a gas stream comprising:

means for feeding and splitting a gas stream into a first gas stream and a second gas stream;

means for providing humidification to at least one of said first gas stream and said second gas stream;

means for measuring the flow rate of said first gas stream and said second gas stream; and

means for combining said first gas stream and said second gas stream.

The gas stream that may be humidified is selected from the group consisting of air, nitrogen, oxygen, hydrogen, helium, argon, carbon dioxide or mixtures of these. The methods of the invention though can be employed on any gas stream that can be humidified.

### BRIEF DESCRIPTION OF DRAWINGS

The FIGURE is a schematic of the humidification process of the invention.

### DETAILED DESCRIPTION OF THE INVENTION

The invention provides for producing a continuously adjustable relative humidification of a gas stream. For purposes of the invention, humidification means the vaporization of any volatile liquid such as water. 100% relative humidity exists when the inert gas is saturated with the volatile liquid's vapor. While in operation any number of inert gases such as air, oxygen, nitrogen, argon and helium may be humidified by a variety of volatile liquids such as water, for purposes of the description, the FIGURE provides for the humidification of dry nitrogen with water vapor.

The FIGURE shows a nitrogen feed 1 through line 2 to a valve assembly 3 which meters the flow of nitrogen into the system. The nitrogen gas at pressure 4 is split into two separate streams 5 and 8. The first nitrogen gas stream 8 is directed through valve 6 at a flow coefficient Cv,1 and the second nitrogen gas stream 5 is directed through valve 9 at a flow coefficient Cv,2. Both flows of nitrogen gas 5 and 8 are controlled by individual flowmeters 7 and 10 which can be adjusted to provide the desired flow rate of each nitrogen gas stream.

The second nitrogen gas stream 5 after passing through valve 9 and flowmeter 10 is directed through line 11 into a humidification unit 20 where it will be humidified to essentially 100%. Although this relative amount of humidification does not have to be 100%, any value will suffice as long as the resultant gas stream is stable. The humidification shown is a bubble column 23 which has an input for the feed of the volatile liquid, here being water, as well as a level detection device 21 and heater 22. The heater 22 is optional but can be employed in achieving the appropriate level of humidification for the gas stream directed to the bubble column.

The now humidified gas stream leaves the bubble column 20 through line 13 where it connects with the first gas stream 8 at a junction 12 where the two streams 8 and 13 can be mixed. The resultant mixed gas stream 14 will have a relative humidity 15 at temperature 16 and pressure 17.

The relative humidity after mixing is essentially equal to the ratio of humidified mass flow (i.e. the second gas stream) to the total mass flow of both the first and second gas streams:

$$RH = \frac{{\dot{m}}_{2}}{\dot{m} + {\dot{m}}_{2}} = \frac{1}{1 + {\dot{m}}_{1} / {\dot{m}}_{2}}$$

The (unchoked) flow rates for the branch flows are given by

$$\dot{m} = {C}_{v} \sqrt{\frac{P \cdot Δ P \cdot SG}{T}}$$

where
SG=Specific gravity relative to air
Cᵥ=Flow coefficient

Because the pressures and temperatures are essentially the same for both branches:

$$\frac{{\dot{m}}_{2}}{{\dot{m}}_{1}} = \frac{{C}_{v , 2}}{{C}_{v , 1}}$$

$$so$$

$$RH = \frac{1}{1 + {C}_{v , 1} / {C}_{v , 2}}$$

Without being bound by theory, this calculation implies that once the variable valves have been adjusted for a particular relative humidity RH, the mixing ratio and RH will remain relatively constant regardless of flow and pressure perturbations.

Control of the relative humidity is accomplished by suitable adjustments of valves 6 and 9, either manually or through control logic that measures or infers the RH of the humidified gas product. Direct measurement of the humidified gas product is possible by either continuous or periodic sampling of the gas stream. Alternatively, the flow rates of the two component gas streams may be measured as shown in the FIGURE. The relative humidity is then inferred using the ratio of these two flows. It is also possible to combine these two methods by using a direct RH measurement to calibrate the indirect flow measurement method.

Further fine control over the relative humidity of the gas stream is possible by controlling the temperature of the liquid in the bubble column using the optional heater in the FIGURE. In general, the risk of liquid existing in the humidified gas product is minimal or non-existent because the bubble column will generally only approach complete saturation. Suitable design should be employed to ensure that any entrained mist is not carried out by the saturated gas steam. The methods of accomplishing this are known in the art and generally involve suitably sizing the discharge piping from the bubble column to ensure liquid will not be entrained in the discharge gas stream. In addition, mist elimination devices may be employed, as well as suitably sloping the discharge piping to ensure any liquid condensate returns in a counter-flow fashion to the bubble column.

Further downstream processing of the humidified gas product is possible to further adjust the temperature and pressure of the humidified product stream. Well known analytical methods exist to predict the relative humidity at a new downstream temperature and pressure, using the known upstream (humidified gas stream) conditions of temperature, pressure and relative humidity.

The humidified gas product stream can be further conditioned by passing it through a suitable filtering device in order to produce a sterile gas product. Such a sterile gas product, at a continuously variable temperature, pressure and relative humidity, may be advantageously employed in jet milling devices for size reduction of materials generally used in the pharmaceutical industry.

As discussed previously, any number of gases such as air, nitrogen, oxygen, hydrogen, helium, argon, carbon dioxide, or mixtures of these gases as well as other gases may be humidified by the methods of the invention.

Any number of liquids may be employed for providing humidity to the dry gas stream in addition to water with the only requirement being that the vapor pressure of the liquid is sufficient to enable production of a gas/vapor mixture.

Modifications can be made to the process identified in the FIGURE for controlling and measuring the saturated and dry gas stream, including the use of addition valving and flowmeters.

Further, the methods for measuring or inferring the RH produced may be modified including any number of RH measurement devices and techniques both continuous and batch.

Downstream or upstream processing of the product gas stream is possible depending upon the desired end properties of the humidified gas stream including using heat exchangers, sterile filtering devices, additional flow and/or pressure control valves and related components and additional gas mixing or flow conditioning means may be employed.

Additional control and adjustment of the various stream components, including the temperature of the liquid in the bubble column may be employed in producing the final humidified product gas stream.

The gas-liquid mixing devices can also be varied in addition to the bubble column to produce the saturated gas stream. The gas/liquid mixers that may be employed will have the primary purpose to produce a saturated gas stream through direct contact with the liquid. Additionally, various types and designs of bubble columns, and methods for producing the bubbles, are within the scope of the invention.

While this invention has been described with respect to particular embodiments thereof, it is apparent that numerous other forms and modifications of the invention will be obvious to those skilled in the art. The appending claims in this invention generally should be construed to cover all such obvious forms and modifications which are within the true spirit and scope of the invention.

Having thus described the invention, what we claim is:

1. A method of humidifying a gas stream comprising the steps of:
a) splitting a dry gas stream into a first gas stream and a second gas stream;
b) feeding said second gas stream to a humidification unit, thereby forming a nearly saturated humidified gas stream; and
c) combining said first gas stream and said humidified gas stream.

2. The method as claimed in claim 1 wherein said gas stream is selected from the group consisting of air, oxygen, nitrogen, argon and helium.

3. The method as claimed in claim 1 wherein the flow of said first gas stream and said second gas stream is controlled by flowmeters.

4. The method as claimed in claim 1 wherein said second gas stream is humidified to about 100% humidity.

5. The method as claimed in claim 1 wherein said humidification unit is a bubble column.

6. The method as claimed in claim 1 wherein said the relative humidity of said combined first and second gas streams is controlled by adjusting the flow rate of said first gas stream and said second gas stream.

7. The method as claimed in claim 6 wherein said adjusting is performed manually or through control logic.

8. The method as claimed in claim 1 wherein the relative humidity of the gas stream is controlled by the temperature of said humidification unit.

9. The method as claimed in claim 1 wherein said humidified gas stream is further passed through a filtering device to produce a sterile humidified gas stream.

10. The method as claimed in claim 9 wherein said sterile humidified gas stream is used in jet milling devices.

11. The method as claimed in claim 1 wherein said gas stream is humidified with water.

12. A method of humidifying a gas stream to a desired amount of humidification comprising the steps:
a) measuring the flow rate of a first gas stream;
b) directing a second gas stream to a humidification unit thereby producing a nearly saturated humidified second gas stream;
c) measuring the flow rate of said humidified second gas stream;
d) combining said first gas stream and said humidified second gas stream to produce said gas stream having the desired level of humidification.

13. The method as claimed in claim 12 wherein said gas stream is selected from the group consisting of air, oxygen, nitrogen, argon and helium.

14. The method as claimed in claim 12 wherein the flow of said first gas stream and said second gas stream is controlled by flowmeters.

15. The method as claimed in claim 12 wherein said second gas stream is humidified to about 100% humidity.

16. The method as claimed in claim 12 wherein said humidification unit is a bubble column.

17. The method as claimed in claim 12 wherein said the relative humidity of said combined first and second gas streams is controlled by adjusting the flow rate of said first gas stream and said second gas stream.

18. The method as claimed in claim 17 wherein said adjusting is performed manually or through control logic.

19. The method as claimed in claim 12 wherein the relative humidity of the gas stream is controlled by the temperature of said humidification unit.

20. The method as claimed in claim 12 wherein said humidified gas stream is further passed through a filtering device to produce a sterile humidified gas stream.

21. The method as claimed in claim 20 wherein said sterile humidified gas stream is used in jet milling devices.

22. The method as claimed in claim 12 wherein said gas stream is humidified with water.

23. An apparatus for providing humidification to a gas stream comprising:
means for feeding and splitting a gas stream into a first gas stream and a second gas stream;
means for providing humidification to at least one of said first gas stream and said second gas stream;
means for measuring the flow rate of said first gas stream and said second gas stream; and
means for combining said first gas stream and said second gas stream.

24. The apparatus as claimed in claim 23 wherein said means for feeding and splitting a gas stream comprises a pipe and valve.

25. The apparatus as claimed in claim 23 wherein said means for providing humidification is a bubble column.

26. The apparatus as claimed in claim 23 wherein said means for measuring the flow rate is a flowmeter.

27. The apparatus as claimed in claim 23 wherein said means for combining said first gas stream and said second gas stream is a junction.

28. The apparatus as claimed in claim 23 further comprising means for sterilizing said humidified gas stream.
